(19) United States
(12) Patent Application Publication
(10) Pub. No.: US 2026/0318171 A1
(43) Pub. Date: Oct. 15, 2026

(54) THERMALLY INSULATED CONTAINER HAVING HYBRID MATERIAL PLUG AND WELL INTERVENTION TOOL MADE THEREWITH

(71) Applicant: Hephae Energy Technology, Spring, TX (US)

(72) Inventors: Gorka Plata, Zaratamo (ES); Peter Harvey, Houston, TX (US); Shraddha Singh, Bilbao (ES)

(21) Appl. No.: 19/687,216

(22) Filed: May 26, 2026

Related U.S. Application Data
(63) Continuation of application No. PCT/US2024/057578, filed on Nov. 26, 2024.
(60) Provisional application No. 63/602,672, filed on Nov. 27, 2023.

(51) Int. Cl. E21B 33/12

(52) U.S. Cl. CPC E21B 33/1208

(57) ABSTRACT

A hybrid material plug comprises at least a first material having a thermal diffusivity of at most 2 E−6 m²/s (square meters per second); and at least one discrete element made from at least a second material having a volumetric heat capacity of at least 2 MJ/m³·°K (mega Joules per cubic meter-degree Kelvin) interspersed within the first material. A vacuum insulated container may comprise a double walled enclosure, wherein the plug is inserted into an opening defined at one end of the enclosure. A well intervention tool includes a pressure resistant housing having the vacuum insulated container therein. At least one temperature sensitive device is disposed in the vacuum insulated container.

### CROSS REFERENCE TO RELATED APPLICATIONS

Continuation of International Application No. PCT/US2024/057578 filed on Nov. 26, 2024. Priority is claimed from U.S. Provisional Application No. 63/602,672 filed Nov. 27, 2023. Both the foregoing applications are incorporated herein by reference in their entireties.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of thermally insulated containers. In some aspects, thermally insulated containers are used in well intervention tools. More specifically, the disclosure relates to thermally insulated containers having extended time before adverse temperature is reached within the container, and for use of such containers in well intervention tools to enable such tools to operate, e.g., at elevated temperatures, for extended periods of time.

The term “well intervention tools” as used herein comprises any instrument or device conveyable along the interior of a subsurface well for performing tasks related to drilling, completion and reworking of the well. Conveyance of the tool(s) may be performed, for example and without limitation, by deploying the tool(s) at the end of an armored electrical cable, at the end of a coiled tubing or by segmented pipe such as drill pipe or completion pipe. In the case of conveyance by coiled tubing or drill pipe, the tool may be deployed during drilling the well.

Some well intervention tools comprise electronic circuitry in order to control various functions performed by the tool, and/or to make measurements within and/or about the well and the earthen formations adjacent to the well Those skilled in the art are aware that many wells, in particular very deep wells and/or wells used to recover geothermal energy may expose the electronic circuits to high temperatures, and in the case of while-drilling operations, expose the circuits to high amplitude shock and vibration. Furthermore, while-drilling well intervention tools may be subjected to high temperature and shock for extended periods of time, e.g., several weeks.

It is known in the art to enclose electronic circuits in well intervention tools within a vacuum-insulated container (e.g., Dewar flask). In the case of while-drilling well intervention, using such vacuum insulated containers has proven to be impractical at least in part because the required structure of the flask includes a large opening at one axial end and because of the extended time such tools are deployed in wells. The axial end of such flasks is generally closed by a plug made from a material that reduces heat transfer between outside the container and inside. For example, the plug may be made from low thermal conductivity material, or a material with a melting point below the expected ambient external temperature, such material having a suitable latent heat of fusion to absorb heat energy by melting and thereby reduce heat entry into the container. While the vacuum insulated part of such flasks provides excellent thermal isolation, the plug typically provides substantially less thermal isolation, and as a result becomes a limiting element for deployment time and/or temperature differential of well intervention tools using such flasks.

Accordingly, there is a need for improved plugs used, e.g., in connection with thermally insulating containers to facilitate use of such containers with well intervention tools. Such tools may include while-drilling well intervention tools, although the scope of the present disclosure is not limited to such tools.

### SUMMARY

One aspect of the present disclosure is a hybrid material plug which may be used in closing an open end of a thermally insulated container such as a vacuum insulated container. A hybrid material plug according to this aspect comprises at least a first material having a thermal diffusivity of at most 2 E−6 m²/s (square meters per second); and at least one discrete element made from at least a second material having a volumetric heat capacity of at least 2 MJ/m³·°K (mega Joules per cubic meter-degree Kelvin) interspersed within the at least first material.

In some implementations, the thermal diffusivity of the at least a first material is at most 1 E−6 m²/s.

In some implementations, a volume fraction of the at least a first material and a volume fraction of the second material in the hybrid material are chosen to maximize a time for a temperature on one side of the plug different from a temperature on another side of the plug to reach a predetermined minimum value.

In some implementations, the at least a first material comprises polyimide polymer, PTFE polymer, silicone rubber or aerogel.

In some implementations, the at least a second material comprises nickel alloy or stainless steel.

In some implementations, the at least one discrete element comprises a disk or ring.

In some implementations, the at least one discrete element comprises a sphere.

In some implementations, the at least one discrete element comprises a block or cube.

Some implementations further comprise a plurality of discrete elements made from the at least a second material that are uniformly spatially distributed within the at least a first material.

In some implementations, the at least one discrete element is shaped to optimize one or more or bending stiffness, torsional stiffness and axial stiffness.

A vacuum insulated container according to another aspect of the present disclosure includes a double walled enclosure defining an interior and an annular space between an outer wall of the double walled container and an inner wall of the double walled container. The double walled enclosure defines at least one opening to the interior. The annular space is arranged to be evacuated. The container further comprises a plug arranged to close the at least one opening. The plug comprises at least a first material having a thermal diffusivity of at most 2 E−6 m²/s (square meters per second) and at least one discrete element made from at least a second material having a volumetric heat capacity of at least 2 MJ/m³·°K (mega Joules per cubic meter-degree Kelvin) interspersed within the at least a first material.

In some implementations, the thermal diffusivity of the at least a first material is at most 1 E−6 m²/s.

In some implementations, a volume fraction of the at least a first material and a volume fraction of the at least a second material in the hybrid material are chosen to maximize a time for a temperature on one side of the plug different from a temperature on another side of the plug to reach a predetermined minimum value.

In some implementations, wherein the at least a first material comprises polyimide polymer, PTFE polymer, silicone rubber or aerogel.

In some implementations, the at least a second material comprises nickel alloys or stainless steel.

In some implementations, the at least one discrete element comprises a disk or ring.

In some implementations, the at least one discrete element comprises a sphere.

In some implementations, the at least one discrete element comprises a block or cubes

Some implementations further comprise a plurality of discrete elements made from the at least a second material uniformly spatially distributed within the at least a first material.

In some implementations, the at least one discrete element is shaped to optimize one or more or bending stiffness, torsional stiffness and axial stiffness.

A well intervention tool according to another aspect of the present disclosure comprises a pressure resistant housing having an adapter arranged to connect the pressure resistant housing to a conveyance. A vacuum insulated container is disposed within the pressure resistant housing. The vacuum insulated container comprises a double walled enclosure defining an interior and an annular space between an outer wall of the double walled container and an inner wall of the double walled container. The double walled enclosure defines at least one opening to the interior. The annular space is arranged to be evacuated. The vacuum insulated container comprises a plug arranged to close the at least one opening. The plug comprises at least a first material having a thermal diffusivity of at most 2 E−6 m²/s (square meters per second) and at least one discrete element made from at least a second material having a volumetric heat capacity of at least 2 MJ/m³·°K (mega Joules per cubic meter-degree Kelvin) interspersed within the at least a first material. At least one temperature sensitive device is disposed within the vacuum insulated container.

In some implementations, the thermal diffusivity of the at least a first material is at most 1 E−6 m²/s.

In some implementations, a volume fraction of the at least a first material and a volume fraction of the at least a second material in the hybrid material are chosen to maximize a time for a temperature on one side of the plug different from a temperature on another side of the plug to reach a predetermined minimum value.

In some implementations, wherein the at least a first material comprises polyimide polymer, PTFE polymer, silicone rubber or aerogel.

In some implementations, the at least a second material comprises nickel alloys or stainless steel.

In some implementations, the at least one discrete element comprises a disk or ring.

In some implementations, the at least one discrete element comprises a sphere.

In some implementations, the at least one discrete element comprises a block or cube.

Some implementations further comprise a plurality of discrete elements made from the at least a second material uniformly spatially distributed within the at least a first material.

In some implementations, the at least one temperature sensitive device comprises electronic circuits.

In some implementations, the at least one discrete element is shaped to optimize one or more or bending stiffness, torsional stiffness and axial stiffness.

Other aspects and possible advantages will be apparent from the description and claims that follow.

### BRIEF DESCRIPTION OF THE DRAWINGS

FIG. 1 shows an example arrangement of components of a well intervention tool having a vacuum insulated container and a hybrid material plug for the container according to the present disclosure.

FIG. 2 shows a cross section of an example structure of component made of different materials in a hybrid material plug according to the present disclosure.

FIG. 3 shows a graph of thermal properties of individual materials with respect to volume fraction in a hybrid material.

FIG. 4 shows a cross section of another example structure of component made of different materials in a hybrid material plug according to the present disclosure.

FIG. 5 shows a cross section of another example structure of component made of different materials in a hybrid material plug according to the present disclosure.

FIG. 6 shows a cross section of another example structure of component made of different materials in a hybrid material plug according to the present disclosure.

FIG. 7A shows a cross section transverse to the longitudinal axis, and FIG. 7B shows a corresponding cross section along the longitudinal axis L of an example implementation of part of a well intervention tool (“tool part”) 50 which may use one or more vacuum insulated containers according to the present disclosure.

### DETAILED DESCRIPTION

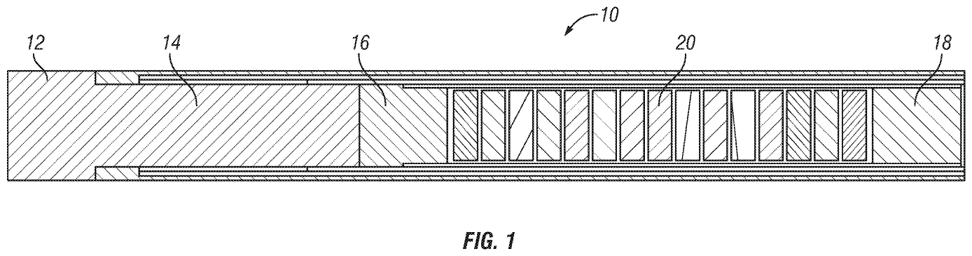

FIG. 1 shows a cross-sectional view of an example implementation of part of a well intervention tool including a vacuum insulated container 10 as it may be mounted within a pressure resistant housing (pressure housing) 12. The vacuum insulated container 10 may be generally U-shaped, having a double wall, wherein an annular space between the inner and outer walls is arranged to be evacuated. By reason of the U shape, the double wall defines an enclosed space. The closed end of the vacuum insulated container 10 may include in the interior thereof a “payload” 18, which comprises one or more devices to be thermally isolated from the ambient exterior environment into which the vacuum insulated container 10 is to be disposed. Space between the payload 18 and an end plug 16 disposed in the opposed, open end of the vacuum insulated container 10 may include a hybrid material plug 20 in accordance with the present disclosure. Structure and composition of the hybrid material plug 20 will be explained in more detail below.

The vacuum insulated container 10 may be physically connected to the pressure housing 12 by an adapter 14 so that fluid under pressure outside the pressure housing 12 is excluded from entering the interior of the pressure housing 12 where the transition is made between the vacuum insulated container 10 and the pressure housing 12. The specific structure of pressure housing 12, adapter 14 and vacuum insulated container 10 are not limitations on the scope of the present disclosure. In other well intervention tool implementations, all functional components may be disposed within a pressure housing so as to make unnecessary the particular adapter shown in FIG. 1.

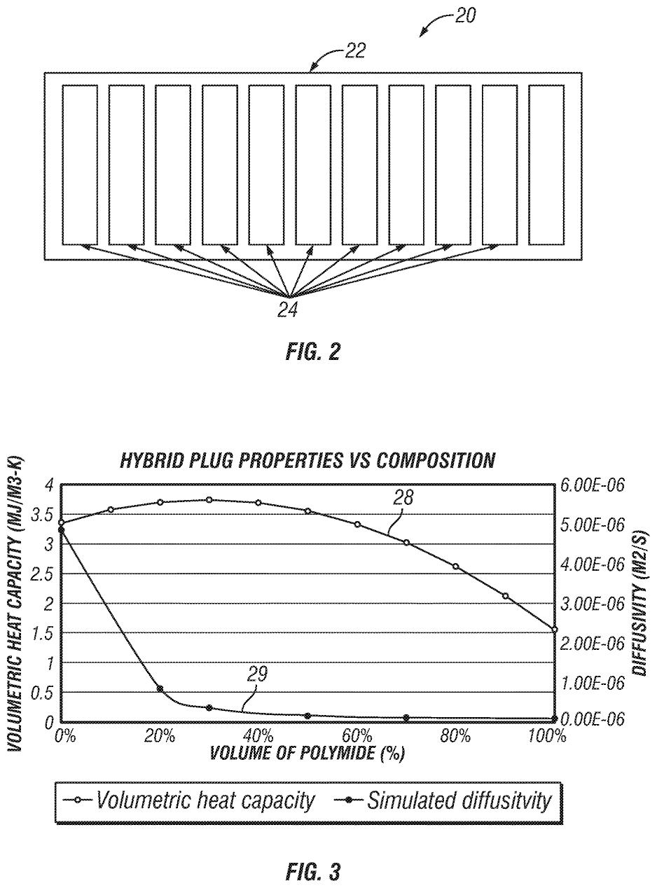

FIG. 2 shows an example implementation of the hybrid material plug 20 according to the present disclosure. At least one, and in the present example implementation, a plurality of longitudinally spaced apart discrete elements, e.g., disks or rings 24 of a high volumetric heat capacity material may be disposed, e.g., uniformly distributed within a low thermal diffusivity material 22, which may be in liquid or gel form prior to cure and may be cured after insertion and placement of the disks 24. In implementations of a hybrid material plug according to the present disclosure, it is contemplated that the individual components or discrete elements of the high volumetric heat capacity (HVHC hereinafter for convenience) material, in the form of disks or any other shape to be described further below, may be approximately uniformly geometrically distributed within the low thermal diffusivity (LTD for convenience hereinafter) material 22. As used in the present disclosure, for a better understanding of suitable materials to be used in accordance with the present disclosure, LTD material may be any material with a diffusivity of at most 2 E−6 m²/s and HVHC material may be any material with a volumetric heat capacity above 2 MJ/m³·°K. In some implementations, the thermal diffusivity of the at least a first material may be at most 1 E−6 m²/s.

An example HVHC material used in simulating functionality of a hybrid material plug according to the present disclosure is stainless steel, and an example LTD material according to the present disclosure may be a polymer such as polyimide.

It has been determined through experimentation (including simulation of time and temperature response) that the amount of time to result in a particular temperature change at the location of the payload (18 in FIG. 1) may be substantially increased by having a hybrid material plug according to the present disclosure.

The LTD material provides insulation properties to the hybrid material, by hindering heat transfer. In some implementations, such as the one shown in FIG. 2, an outer “shell” of LTD material surrounds the HVHC material. On the other hand, the HVHC material is provided to hold as much energy as possible in the form of heat. In some implementations, such as in well intervention tools, it is desirable to have the HVHC material at an initial temperature substantially below the expected ambient environment temperature, whereby heat energy entering the hybrid material plug (20 in FIG. 1) may be absorbed and stored by the HVHC material and thereby not move to the interior of the vacuum insulated container (10 in FIG. 1).

As a result, a hybrid material plug made according to the present disclosure may provide better performance in maintaining a component in a well intervention tool below a certain threshold temperature for a longer time, because the hybrid material plug benefits from combination of insulation (LTD material) and high energy storage (HVHC material).

However, the performance of any particular hybrid material plug may depend on the fractional amounts of the LTD and HVHC materials in the overall plug composition and the HVHC material shape and spatial distribution throughout the LTD material.

A fractional amount of the LTD and the HVHC materials in any particular composition of hybrid material that provide best overall heat transfer reducing performance may depend on the characteristics of the specific LTD and HVHC materials used. As an example, the graph in FIG. 3 shows approximate effective LTD and HVHC performance as a function of the LTD material volume fraction in the composition in the case of polyimide as the LTD material and stainless steel as the HVHC material. It may be observed that the effective heat capacity of the hybrid material reaches a peak at about 30 percent volume fraction of the overall composition, while the effective thermal diffusivity drops rapidly from a maximum at zero fraction LTD material, the thermal diffusivity response exhibiting a sharp change in rate of decrease with respect to increased fractional amount of LTD material just over 20 percent by volume. In some implementations, the fractional amount of LTD material and HVHC material may be chosen to create the longest delay time before temperature inside the vacuum insulated container (10 in FIG. 1) reaches a threshold value. Expressed more generally, the fractional amounts of material may be chosen to maximize a time for a temperature difference between one side of the plug and the other side of the plug to reach a predetermined minimum threshold value.

Uniform spatial distribution of the HVHC material within the LTD material may improve overall plug thermal performance by increasing the number of HVHC material discrete elements and correspondingly making the HVHC material elements smaller in size. A result may be better distribution of the mass subject to storing heat energy and a higher number of LTD material surfaces would make the hybrid material plug even more effective. A hybrid material plug made according to the present disclosure is not limited to any minimum or maximum division of the volumes of each material into discrete elements; a plug according the present disclosure may be designed according to the requirements and of any specific use, and by manufacturing capabilities, among other considerations. It will be appreciated that while the present disclosure is expressed in terms of insulating the interior of the vacuum insulated container from high external temperature, as would ordinarily be the case with well intervention tools, a hybrid material plug according to the present disclosure is equally applicable to insulate the interior of the vacuum sealed container from low external temperature.

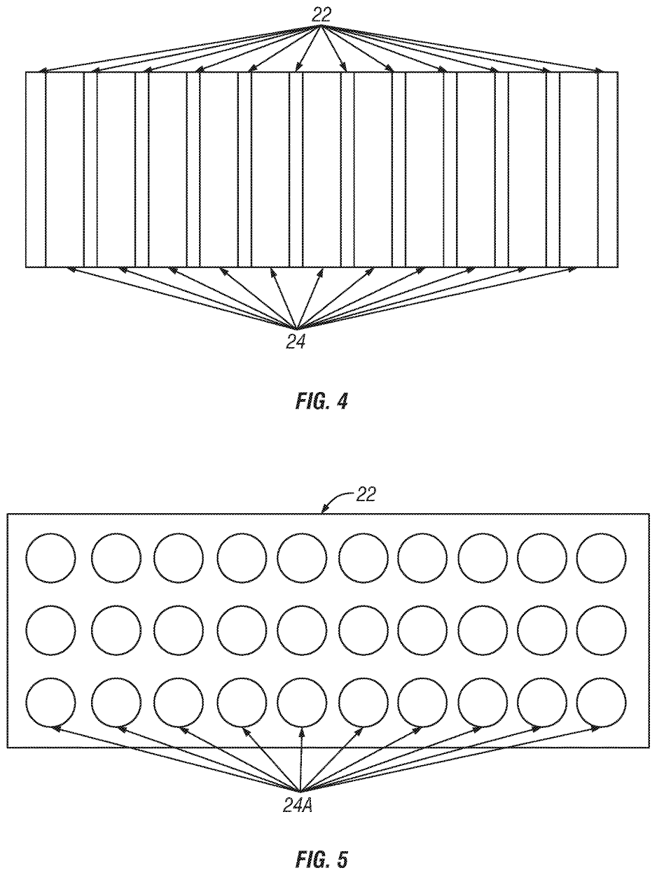

Similarly, the shape of the LTD material and/or the HVHC material elements are not limitations on the scope of the present disclosure. In the implementation shown in FIG. 2, the hybrid material plug comprises a plurality of HVHC material disks disposed within a shell made of LTD material. In some implementations, and referring to FIG. 4, the disks 24 of HVHC material may be separated longitudinally by the LTD material 22; however, the LTD material 22 need not cover the perimeter of the HVHC material disks 24.

In some implementations, and referring to FIG. 5, the HVHC material may be disposed in the LTD material 22 in the form of spheres 24A. The spheres 24A may in some implementations be uniformly spatially distributed within the LTD material 22.

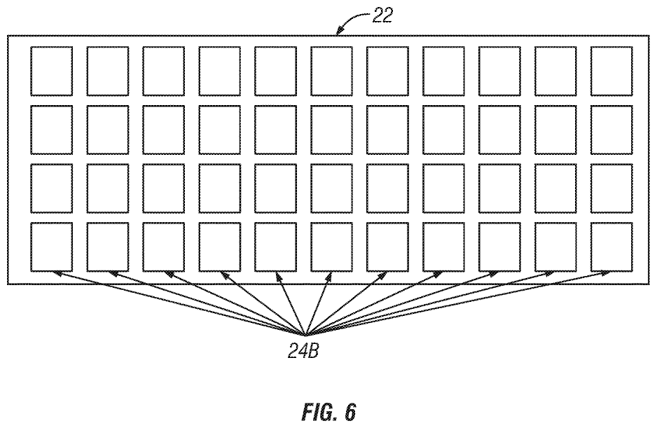

FIG. 6 shows another example implementation in which the HVHC material is disposed within the LTD material 22 in the form of blocks or cubes 24B. The blocks or cubes 24B may be uniformly spatially distributed within the LTD material 22.

In some implementations, more than one LTD material or HVHC material can be used, resulting in a hybrid material consisting of three or more materials. For example, if it is desired to absorb more heat from one side of a hybrid material plug than from another side, whilst having high volumetric heat capacity (e.g., in the case of having a heat source disposed inside the vacuum insulated container, such as by having self-heating components in the payload), copper could be added to the HVHC material elements disposed close to that end, and stainless steel HVHC material elements may be disposed in the rest of the plug.

In some implementations, the shape of and the spatial distribution within the LTD material of the at least one discrete element of the HVHC material may be selected to provide the hybrid material plug with structural characteristics required to support physical dynamic loads which may be imparted to the hybrid material plug when it is used, for example, in while-drilling well intervention tools, while making the plug susceptible to easy assembly as required into an insulated container. The spatial distribution of the HVHC material within the LTD material may be optimized to provide the required bending, axial, and torsional stiffness. Additionally, the HVHC material may include features such as mounting holes, threads and/or other features to support the assembly requirements within a while drilling well intervention tool.

Similarly, if better insulation is desired in some specific parts of the hybrid material plug, different LTD materials can be used. For example, if one side (or axial end) of the plug requires better insulation than the other side (or axial end) of the plug, aerogels may be used for the LTD material on one longitudinal end of the hybrid material plug, while silicone rubber may be used on the other longitudinal end. In some implementations, different fractional volumes and element distributions may be placed in one side of the hybrid material plug than in the other.

Although the example vacuum insulated containers shown and described herein have an opening at one longitudinal end to be closed using a hybrid material plug according to the present disclosure, the scope of the present disclosure is not limited to such vacuum insulated containers. Vacuum insulated containers having openings at both longitudinal ends are equally within the scope of the present disclosure.

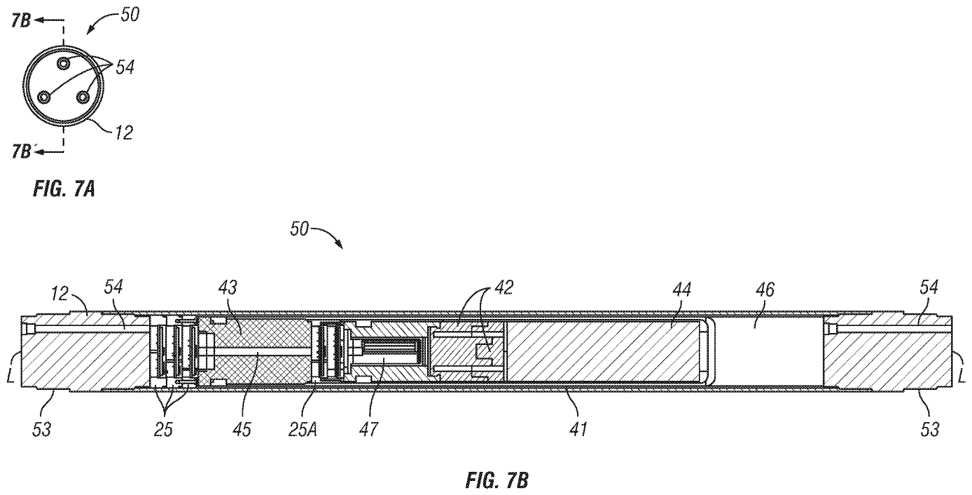

FIG. 7A shows a cross section transverse to the longitudinal axis, and FIG. 7B shows a corresponding cross section along the longitudinal axis L of an example implementation of part of a well intervention tool (“tool part”) 50 which may use one or more vacuum insulated containers according to the present disclosure. Electronic components of the well intervention tool part 50 may be disposed inside an elongated, pressure resistant housing 12 (corresponding to reference numeral 12 in FIG. 1), which may be generally cylindrically shaped and have pressure resistance capability to withstand the maximum fluid pressure expected in any well in which the intervention tool is to be operated. The pressure resistant housing 12 may comprise at either or both longitudinal ends an adapter 53, which enables mechanical and electrical connection to another part of the well intervention tool or to a conveyance such as armored electrical cable, slickline, coiled tubing or jointed tubing. One or more through passages 54 may provide places to disposed electrical wiring and/or fluid channels through the tool part 50, depending on the particular well intervention tool and any other devices to which the tool part 50 may be connected.

In the present example implementation, the insulated container (e.g., a vacuum insulated container such as a Dewar flask) 41 may be disposed within the pressure resistant housing 12. The thermally insulated container 41 may comprise within its interior other components for temperature control, for example and without limitation, one or more thermoelectric coolers 47, thermal regulator valves 42 and a heat sink 44, which may be made from metal. A structural support 46 holds the thermally insulated container in place within the pressure resistant housing 12 on one longitudinal end. The other longitudinal end of the thermally insulated container 41 may comprise a thermally insulated plug 10 according to the present disclosure, which thermally insulated plug 10 may in some implementations comprise an optical and/or electrical waveguide 45 for signal communication and/or electromagnetic induction couplings for communicating power and signals between temperature sensitive devices, e.g., electronic circuits disposed in the vacuum insulated container 10 and in other devices, e.g., electronic circuits, located outside the vacuum insulated container 41.

Advantageously, a well tool part such as shown at 50 in FIG. 7B may form part of a well intervention tool wherein the well tool part 50 is disposed within a fluid channel inside the well intervention tool, e.g., a measurement while drilling (MWD) or logging while drilling (LWD) tool. In such tools, fluid pumped from surface through a central bore in the tool conveyance (e.g., drill pipe, coiled tubing, jointed tubing or the like) may act to remove heat from the tool part 50.

In light of the principles and example implementations described and illustrated herein, it will be recognized that the example implementations can be modified in arrangement and detail without departing from such principles. The foregoing discussion has focused on specific implementations, but other configurations are also contemplated. In particular, even though expressions such as in “an implementation,” or the like are used herein, these phrases are meant to generally reference implementation possibilities, and are not intended to limit the disclosure to particular implementation configurations. As used herein, these terms may reference the same or different implementations that are combinable into other implementations. As a rule, any implementation referenced herein is freely combinable with any one or more of the other implementations referenced herein, and any number of features of different implementations are combinable with one another, unless indicated otherwise. Although only a few examples have been described in detail above, those skilled in the art will readily appreciate that many modifications are possible within the scope of the described examples. Accordingly, all such modifications are intended to be included within the scope of this disclosure as defined in the following claims.

What is claimed is:

1. A hybrid material plug, comprising:
at least a first material having a thermal diffusivity of at most 2 E−6 m²/s (square meters per second); and
at least one discrete element made from at least a second material having a volumetric heat capacity of at least 2 MJ/m³·°K (mega Joules per cubic meter-degree Kelvin) interspersed within the at least a first material, wherein a volume fraction of the at least a first material and a volume fraction of the at least a second material in the hybrid material are chosen to maximize a time for a temperature on one side of the plug different from a temperature on another side of the plug to reach a predetermined minimum value.

2. The plug of claim 1 wherein the thermal diffusivity of the at least a first material is at most 1 E−6 m²/s.

3. The plug of claim 1 wherein the at least a first material comprises polyimide polymer, PTFE polymer, silicone rubber or aerogel.

4. The plug of claim 1 wherein the at least a second material comprises nickel alloys or stainless steel.

5. The plug of claim 1 wherein the at least one discrete element comprises a disk or a ring.

6. The plug of claim 1 wherein the at least one discrete element comprises a sphere.

7. The plug of claim 1 wherein the at least one discrete element comprises a block or cube.

8. The plug of claim 1 further comprising a plurality of discrete elements made from the at least a second material uniformly spatially distributed within the at least a first material.

9. The plug of claim 1 wherein the at least one discrete element is shaped to optimize one or more or bending stiffness, torsional stiffness and axial stiffness.

10. A vacuum insulated container, comprising:
a double walled enclosure defining an interior and an annular space between an outer wall of the double walled container and an inner wall of the double walled container, the double walled enclosure defining at least one opening to the interior, the annular space arranged to be evacuated; and
a plug arranged to close the at least one opening, the plug comprising at least a first material having a thermal diffusivity of at most 2 E−6 m²/s (square meters per second) and at least one discrete element made from at least a second material having a volumetric heat capacity of at least 2 MJ/m³·°K (mega Joules per cubic meter-degree Kelvin) interspersed within the at least a first material, wherein a volume fraction of the at least a first material and a volume fraction of the at least a second material in the hybrid material are chosen to maximize a time for a temperature on one side of the plug different from a temperature on another side of the plug to reach a predetermined minimum value.

11. The container of claim 10 wherein the thermal diffusivity of the at least a first material is at most 1 E−6 m²/s.

12. The container of claim 10 wherein the at least a first material comprises polyimide polymer, PTFE polymer, silicone rubber or aerogel.

13. The container of claim 10 wherein the at least a second material comprises nickel alloys or stainless steel.

14. The container of claim 10 wherein the at least one discrete element comprises a disk or a ring.

15. The container of claim 10 wherein the at least one discrete element comprises a sphere.

16. The container of claim 10 wherein the at least one discrete element comprises a block or cube.

17. The container of claim 10 further comprising a plurality of discrete elements made of the at least a second material uniformly spatially distributed within the at least a first material.

18. The container of claim 10 wherein the at least one discrete element is shaped to optimize one or more or bending stiffness, torsional stiffness and axial stiffness.

19. A well intervention tool, comprising:
a pressure resistant housing having an adapter arranged to connect the pressure resistant housing to a conveyance;
a vacuum insulated container disposed within the pressure resistant housing, the vacuum insulated container comprising a double walled enclosure defining an interior and an annular space between an outer wall of the double walled container and an inner wall of the double walled container, the double walled enclosure defining at least one opening to the interior, the annular space arranged to be evacuated, the vacuum insulated container comprising a plug arranged to close the at least one opening, the plug comprising at least a first material having a thermal diffusivity of at most 2 E−6 m²/s (square meters per second) and at least one discrete element made from at least a second material having a volumetric heat capacity of at least 2 MJ/m³·°K (mega Joules per cubic meter-degree Kelvin) interspersed within the at least a first material, wherein a volume fraction of the at least a first material and a volume fraction of the at least a second material in the hybrid material are chosen to maximize a time for a temperature on one side of the plug different from a temperature on another side of the plug to reach a predetermined minimum value; and
at least one temperature sensitive device disposed within the vacuum insulated container.

20. The tool of claim 19 wherein the thermal diffusivity of the at least a first material is at most 1 E−6 m²/s.

21. The tool of claim 19 wherein the at least a first material comprises polyimide polymer, PTFE polymer, silicone rubber or aerogel.

22. The tool of claim 19 wherein the at least a second material comprises nickel alloys or stainless steel.

23. The tool of claim 19 wherein the at least one discrete element comprises a disk or ring.

24. The tool of claim 19 wherein the at least one discrete element comprises a sphere.

25. The tool of claim 19 wherein the at least one discrete element comprises a block or cube.

26. The tool of claim 19 further comprising a plurality of discrete elements made from the at least a second material uniformly spatially distributed within the at least a first material.

27. The tool of claim 19 wherein the at least one temperature sensitive device comprises electronic circuits.

28. The tool of claim 19 wherein the at least one discrete element is shaped to optimize one or more or bending stiffness, torsional stiffness and axial stiffness.
